(19) United States
(12) Patent Application Publication
(10) Pub. No.: US 2011/0138633 A1
(43) Pub. Date: Jun. 16, 2011

(54) TOOL FOR FINISHING A WELD JOINT BETWEEN TWO WIRE ELECTRODES

(75) Inventors: Spyros P. Mellas, Waterford, MI (US); Jay Hampton, Lenox, MI (US)

(73) Assignee: GM GLOBAL TECHNOLOGY OPERATIONS, INC., Detroit, MI (US)

(21) Appl. No.: 12/639,453

(22) Filed: Dec. 16, 2009

(51) Int. Cl. B26B 27/00; B26B 5/00

(52) U.S. Cl. 30/169; 30/278; 30/320

(57) ABSTRACT

A tool for scraping, grinding, smoothing, machining or otherwise finishing a weld joint between two wire electrodes, such as those used in gas metal arc welding (GMAW) systems. When two wire electrode ends are coaxially joined together by a process such as butt welding, it creates a weld joint that can jam a GMAW welding gun or other device with tight dimensional tolerances. The tool described herein may be used to finish such a weld joint so that a relatively uniform cross-sectional shape and/or size is produced across the weld joint, thus, making it less likely to jam the welding gun. According to an exemplary embodiment, the tool is designed to fit over two wire electrodes connected by a weld joint, and generally includes a housing assembly and a cutting device.

### TECHNICAL FIELD

The present invention generally relates to tools and, more particularly, to tools that may be used to scrape, grind, smooth, machine or otherwise finish weld joints between two wire electrodes, such as those employed in gas metal arc welding (GMAW) operations.

### BACKGROUND

Gas metal arc welding (GMAW) is an arc welding process in which a consumable wire electrode and a shielding gas are provided to a welding gun and are used in the welding process. There are a number of different variations and offshoots of GMAW, including metal inert gas (MIG) welding, metal active gas (MAG) welding, as well as globular, short-circuiting, spray and pulsed-spray GMAW, to name a few. Most, if not all, GMAW processes require a consumable wire electrode that feeds through the welding gun or torch.

For large manufacturing operations that include automatic GMAW stations, the consumable wire electrode is often provided in large wire spools (e.g., 500 pound spools). When a spool such as this nears its end, the operator typically must choose between letting the spool run out and then feeding a new spool—this requires a scheduled break to replace the spools—or attaching the end of the nearly finished spool with the beginning of a new spool by way of a butt weld or the like. If the operator allows the spool to run out, then the welding process ceases as soon as the end of the spool passes a wire feed unit; this may result in damage to certain components of the welding gun and usually leaves several feet of unused wire electrode in the apparatus. If the operator uses a scheduled break to swap out spools, then there is usually no damage to the equipment but a lot of unused wire electrode is left in the machine and must be scrapped. In both of the preceding techniques, a new spool must be fed through the system which results in increased down time and labor. Thus, there may be certain situations where butt welding or otherwise coaxially joining the end of a first spool to the beginning of a second spool is desirable. This type of trunk-to-tail attachment may go on for many spools and may provide the welding system with a continuous supply of uninterrupted wire electrode.

Because of tight dimensional tolerances, a butt weld between two wire electrode ends that is not smooth (e.g., that has an increased cross-sectional shape and/or size due to flash or a weld pool) can jam a welding gun. Thus, it can be helpful to provide a consumable wire electrode with joined ends that maintains a generally uniform cross-sectional shape and/or size across the weld joint.

### SUMMARY

According to one exemplary embodiment, there is provided a tool for finishing a weld joint where the tool may include a housing assembly and a cutting device. The housing assembly has a first housing member, a second housing member and an internal bore, wherein the internal bore is located between the first and second housing members. The cutting device is mounted in the housing assembly and has a cutting surface that extends into the internal bore. In an open position, the first and second housing members are separated from each other so that the internal bore can receive the weld joint; and in a closed position, the first and second housing members are brought together so that the cutting surface can finish the weld joint.

According to another exemplary embodiment, there is provided a tool for finishing a weld joint where the tool may include a housing assembly and a cutting device. The housing assembly has an internal bore extending the length of the housing assembly. The cutting device is mounted in the housing assembly and has a cutting surface extending into the internal bore. In a closed position, the housing assembly clamps two wire electrodes that are connected together by the weld joint so that rotation of the tool around the two electrodes causes the cutting surface to finish the weld joint.

### BRIEF DESCRIPTION OF THE DRAWINGS

Preferred exemplary embodiments of the invention will hereinafter be described in conjunction with the appended drawings, wherein like designations denote like elements, and wherein:

FIG. 1 is a schematic view of an exemplary gas metal arc welding (GMAW) system that includes a number of individual components, including an exemplary welding gun that is enlarged in order to illustrate certain details;

FIG. 2 is a perspective view of an exemplary tool for finishing a weld joint between two wire electrodes, such as those used in the GMAW system of FIG. 1, and it is shown in an open position;

FIG. 3 is a perspective view of the tool in FIG. 2, but it is shown in a closed position; and

FIG. 4 is a cross-sectional view of the tool in FIG. 2 shown in the closed position.

### DETAILED DESCRIPTION OF THE PREFERRED EMBODIMENTS

The tool described below may be used to scrape, grind, smooth, machine or otherwise finish a weld joint or other interface between two wire electrode ends. Typically, when two wire electrode ends are coaxially joined together by a process such as butt welding, it creates flash or some other type of weld pool that makes the weld joint diametrically larger than the adjacent wire electrode sections. As previously explained, this diametrically increased section can jam a welding gun that has tight dimensional tolerances. By removing material and finishing the weld joint between the two wire electrode ends, an uninterrupted length of wire electrode may be formed that is dimensionally and cross-sectionally uniform across the weld joint. This uninterrupted wire electrode does not jam the welding gun when a transition is made from one wire spool to another and, as far as the welding gun is concerned, acts as a single piece of consumable wire electrode. Before describing the tool of the present application, a brief description of an exemplary GMAW system 10 is provided; this is an example of the type of system that may benefit from using the tool described below.

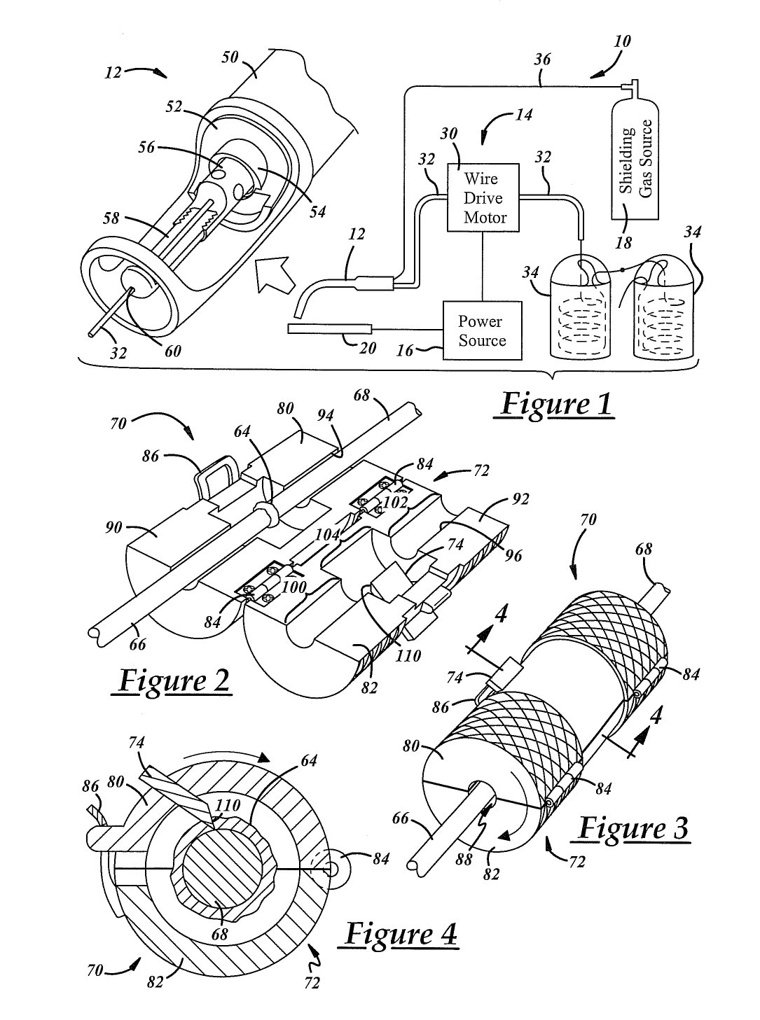

Beginning with FIG. 1, there is shown a schematic diagram of an exemplary gas metal arc welding (GMAW) system 10 that includes a welding gun 12, a wire electrode source 14, a power source 16, a shielding gas source 18, and a metal work piece 20. Wire electrode source 14 may include a motor-driven wire feed unit 30 that automatically retrieves a consumable wire electrode 32 from one or more barrels 34 that house the wire and provides the consumable wire electrode to a handle of welding gun 12. Power source 16 is electrically connected to both the consumable wire electrode 32 and the metal work piece 20 so that a significant voltage drop is created between the tip of the wire electrode and the metal work piece. Power source 16 may provide DC and/or AC power to GMAW system 10, and can be controlled or manipulated according to a number of different methods known in the art. Shielding gas source 18 provides a supply of a shielding gas—such as argon, helium, carbon dioxide, hydrogen, nitrogen, oxygen or some combination thereof—to the handle of welding gun 12 via a gas conduit 36. Work piece 20 can be made from one of a number of types of metal or other materials, so long as it is electrically conductive. This may include, for example, aluminum, stainless steel, steel, as well as other ferrous- and non-ferrous materials known in the art. Although the present description is directed to an exemplary embodiment where an operator manually engages the welding gun, it should be appreciated that robotic or automated applications may also be used.

Welding gun 12, also referred to as a welding torch, supplies both the consumable wire electrode 32 and the shielding gas necessary to produce a shielded arc. According to the exemplary embodiment shown here, welding gun 12 includes a handle 50, an insulative sheathing 52, a conductive insert 54, a shielded gas diffuser 56, contact tip 58, and the consumable wire electrode 32. Handle 50 is an insulated handle for the operator and typically includes a switch (not shown) that, when activated, causes the wire electrode source 14 to feed the wire, the power source 16 to provide power, and the shielding gas source 18 to send shielding gas to the welding gun. Insulative sheathing 52 can be made from a dielectric material or the like and electrically insulates the various conductive parts of the welding gun from the operator or robot. The conductive insert 54 is preferably made of a conductive metal, such as brass, and is threaded on an inner surface to receive shielded gas diffuser 56, which is threaded on an outer surface. Shielded gas diffuser 56 is a gas nozzle and is in fluid communication with gas conduit 36 so that it can provide shielded gas to the welding area. One or more orifices can be seen on the exemplary diffuser 56, and can be selected to control the volume and direction of gas flow. Contact tip 58 is preferably made from a conductive metal like copper, and is electrically connected to power source 16 so that it can provide consumable wire electrode 32 with electrical energy while physically guiding or directing it to the welding area. Contact tip 58 may be threaded into gas diffuser 56, as shown in the exemplary drawing, and includes an axial bore 60 for accommodating consumable wire electrode 32.

As shown in this exemplary illustration, the inner diameter of the axial bore 60 of contact tip 58 is very close in size to the outer diameter of the consumable wire electrode 32; that is, the tolerance between these components is small enough that the wire electrode is allowed to feed through the contact tip, yet maintain an electrical contact between the components. Accordingly, if an enlarged section of wire electrode were to come through welding gun 12, such as the type caused by flash from a weld joint, it could cause welding gun 12 to jam, buckle or otherwise experience wire feed problems. Some examples of consumable wire electrodes that are commonly used in GMAW systems include silicon bronze, aluminum and steel wires having diameters between 0.8 mm and 1.6 mm.

During general operation, power source 16 is electrically connected to both consumable wire electrode 32 and metal work piece 20 such that a significant voltage drop is established across an air gap that separates a tip end of the consumable wire electrode from a surface of the metal work piece; this air gap is sometimes referred to as the “stickout distance.” This voltage drop, in turn, creates an electric arc between the tip of consumable wire electrode 32 and work piece 20 that is surrounded by a stream of shielding gas provided by gas conduit 36. As the welding operation continues, consumable wire electrode 32 is used up and additional wire from wire spool 34 is needed to take its place. Because the structure and operation of a GMAW system and a welding gun is generally known, the description now turns to exemplary tool 70.

FIGS. 2-4 show an exemplary tool 70 that may be used to scrape, grind, smooth, machine or otherwise finish a weld joint 64 between two wire electrodes 66, 68. This produces a relatively uniform cross-sectional shape and/or size across weld joint 64 which helps prevent GMAW system 10, particularly welding gun 12, from getting jammed, as described above. The term “finishing,” as well as its various verb forms, broadly refers to any process or technique, whether it be manual or automated, where material is removed from a weld joint. This includes, but is not limited to, scraping, sanding, grinding, machining and/or other material removal operations. According to this particular embodiment, tool 70 is designed to fit over wire electrodes 66, 68 and generally includes a housing assembly 72 and a cutting device 74.

Housing assembly 72 provides a structural foundation for the tool and provides a user with something to grip onto when using the tool to finish a weld joint, as will be explained. Although housing assembly 72 may be provided according to a number of different arrangements, the exemplary embodiment shown here is generally cylindrical in shape, has a diameter of about 10 mm-75 mm, an axial length of about 50 mm-200 mm, and is made from a suitable material such as a metal, a metal alloy (e.g., tool steel), a rigid plastic, or a combination thereof. This is, of course, only one potential embodiment, as the characteristics of the housing assembly may depend on the particular application with which it is used and could certainly vary from the exemplary embodiment shown and described here. According to another potential embodiment, the housing assembly 72 could be more disk-shaped as opposed to cylindrical-shaped, as in the case of a split thread chaser or similar tool for example. In such an embodiment, the housing assembly 72 could include a much shorter axial length, relative to its diameter, than that of the exemplary embodiment shown here. Other housing assembly embodiments are possible as well. According to the exemplary embodiment shown here, housing assembly 72 includes a first housing member 80, a second housing member 82, a hinge 84, and a locking mechanism 86.

The first and second housing members 80, 82 may be cylindrical halves split along an axial direction of the housing assembly; that is, split or partitioned along an imaginary plane that contains a longitudinal or central axis of the housing assembly. First and second housing members 80, 82 may further include interior surfaces 90, 92 that include grooves 94, 96, respectively, where the grooves face or oppose one another when the housing assembly is in a closed position such that they define an internal bore 88 (see FIG. 3). Grooves 94, 96 may be carved out of or otherwise formed into interior surfaces 90, 92 of the first and second housing members such that they are complementary in size and shape. Grooves 94, 96 can be the same or can differ in size and shape, including the exemplary semi-circular cross-sectional shape shown here which is designed to clamp wire electrodes 66, 68 when the tool is in the closed position. With reference to FIG. 2, there is shown an exemplary groove 96 that includes three separate bore segments: a first groove segment 100 that is located on a first side of weld joint 64 and opposes wire electrode 66, a second groove segment 102 that is located on a second side of the weld joint and opposes wire electrode 68, and a third groove segment 104 that is located between the first and second groove segments and accommodates cutting device 74. The third groove segment 104 is preferably larger in diameter than the first and second groove segments 100, 102 in order to accommodate a diametrically enlarged weld joint 64 and provide for the finishing or removal of flash from the weld joint. Other housing assembly member, interior surface, groove and/or bore configurations and arrangements are certainly possible, as the ones shown here are merely exemplary. For instance, the first and second housing members may be disk or annular halves, as opposed to the cylindrical halves shown in the drawings.

Hinge 84 may be used to pivotally attach the first and second housing members 80, 82 together so that they can transition between open and closed positions. An open position is illustrated in FIG. 2, while closed positions are shown in FIGS. 3 and 4. Hinge 84 may use different hinging mechanisms, including those having one, two or more individual hinges (the exemplary embodiment shown here includes two separate hinge components). The hinging arrangement shown in FIGS. 2-4 allows for pivotal movement where the two housing members 80, 82 pivot away from one another along a pivot axis that that is parallel to the longitudinal axis of the tool and passes through hinges 84. This is only one potential hinging arrangement, as it is also possible for hinge 84 to provide for pivotal movement about a pivot axis that is perpendicular to the longitudinal axis of the tool. For example, first and second housing members 80, 82 could be pivot in a scissor-like movement where interior surfaces 90, 92 stay facing or opposing one another during the pivotal movement. In another embodiment, hinge 84 could be omitted altogether so that the housing assembly 72 can simply be opened and closed without pivotal movement from a hinge. In this embodiment, the two cylindrical halves or housing members 80, 82 simply come apart and attach to one another through one or more locking mechanisms, such as buckles, screws, clasps or other devices for securing the members together.

Locking mechanism 86 attaches or secures the first and second housing members together and can include one of a number of different types of devices and mechanisms. For instance, locking mechanism 86 can simply include a latch, buckle, clasp, set screw, thumb screw, a quarter-turn lock, or any other device that can secure the first and second housing members together in a closed position. This way, the housing assembly 72 does not inadvertently open when tool 70 is being used to smooth, machine or otherwise finish weld joint 64. In the example where hinges have been omitted from tool 70 such that the two housing members 80, 82 simply come apart, the tool may include locking mechanisms on both sides of the housing assembly 72; that is a first locking mechanism 86 as shown in FIG. 2, as well as a second locking mechanism in place of hinges 84 (the first and second locking mechanisms are about 180° separated from each other). Other locking mechanism arrangements are certainly possible.

Cutting device 74 is mounted in housing assembly 72 and has a cutting surface 110 that extends into internal bore 88 so that the cutting surface can finish the weld joint 64 during use of the tool. Skilled artisans will appreciate that the cutting device 74 can include any suitable component that can scrape, grind, smooth, machine or otherwise finish the weld joint 64, including the exemplary scraper blade shown in the drawings. The cutting device may be mounted in a generally radial direction of the housing assembly (best shown in FIG. 4) so that the cutting surface 110 is at the distal end of the cutting device, which in this case is a scraper blade. Cutting surface 110 is shown here as a beveled or angled cutting or scraping surface which promotes better results when the tool is rotated in a certain direction (e.g., the clockwise direction in FIG. 4). Some suitable materials for cutting device 74 and/or cutting surface 110 include tool steel, carbide steel, other types of hardened steel, diamond-tipped materials, etc. Other cutting device besides the exemplary scraper blade shown here may certainly be used, including grinding pieces, abrasive pieces, etc. It is also possible for multiple cutting devices (e.g., two, three, four or more) to be mounted in housing assembly 72 and for each cutting device to contribute to finishing the weld joint 64. Sometimes the cutting device is fragile; in such a case, it may be beneficial to orient the cutting surface such that it has as much of an edge or surface contacting the weld joint as possible. This includes orientations other than the exemplary one shown here.

Cutting device 74 may also be adjustable and/or replaceable. In an adjustable embodiment, cutting device 74 could be maintained within the housing assembly 72 by a set screw or the like so that the depth in which it penetrates into internal bore 88 can be adjusted. The penetration depth could be calibrated for wire electrode of different sizes and shapes, or the penetration depth could be periodically changed to account for wear and tear on the cutting surface. It is also possible to adjust the angle of inclination at which cutting device 74 confronts weld joint 64; this angle may be steeper or shallower than the exemplary angle shown in FIG. 4. In a replaceable embodiment, cutting device 74 could simply be swapped out if a new cutting surface was needed or for wire electrodes and/or weld joints of different shapes and sizes. The tool 70 could be designed to accommodate different length blades and other cutting devices of various shapes and sizes, for instance.

Although not shown in the drawings, it is possible for tool 70 to be used in conjunction with some type of clamping device that maintains the two electrode wires 66, 68 in place while the tool 70 scrapes, grinds, smoothes, machines or otherwise finishes the weld joint 64. Such a clamping device could be provided according to a number of different configurations. For instance, the clamping device could be mounted to a fixture and include two separate clamps, where a first clamp firmly grips electrode wire 66 on one side of the tool and a second clamp firmly grips electrode wire 68 on a second side of the tool such that the clamping device prevents the wire electrodes and the weld joint from twisting, turning, kinking, breaking, etc. during use of the tool. The clamping device could be physically connected to the tool 70 so that the tool can rotate while the clamping device stays stationary, or the clamping device and tool could be separate devices that are not physically attached to one another. In another embodiment, tool 70 actually includes the clamping device (e.g., an internal sleeve that remains stationary while the tool rotates) which prevents the electrode wires 66, 68 from twisting during use of the tool. Skilled artisans should appreciate that any type of device or arrangement that stabilizes wire electrodes 66, 68 and/or weld joint 64 may be used with tool 70, including those that are physically connected to the tool and those that are separated from the tool. It is also possible for tool 70 to be mounted to a fixture and located at a downstream position from the welding device that creates the weld joint 64 so that the tool can finish the weld joint after it is created.

In use, an operator engages tool 70 by clamping it around wire electrodes 66, 68 and rotating or turning it so that cutting surface 110 smoothes, machines or otherwise finishes weld joint 64. By removing material from weld joint 64, a smooth and uniform transition is made from one wire electrode to the next across the weld joint. Thus, reducing the likelihood of jamming a GMAW system or the like due to an enlarged weld joint due to welding flash, etc. Beginning with tool 70 in an open position (such as that shown in FIG. 2), a user places the tool around the already welded wire electrodes such that wire electrode 66 is received in a first groove segment 100, wire electrode 68 is receive in a second groove segment 102, and the weld joint 64 is accommodated in a third groove segment 104. Once properly positioned, the two housing members 80, 82 can be brought together and locked up so that the tool is firmly secured around the wire electrodes in a closed position (such as that shown in FIGS. 3 and 4). At this point, the user can simply rotate the tool 70 around the wire electrodes and weld joint so that the cutting surface 110 of cutting device 74 scrapes, machines, or otherwise removes material from the weld joint 64. As mentioned above, it may be desirable for the user to engage the use of an additional clamping device to secure and maintain the wire electrodes in place during operation. Depending on the size and/or constituency of the weld joint, several rotations of the tool may be necessary in order to create a smooth weld joint 64 that is flushly aligned with the adjacent wire electrodes 66, 68. Once this occurs, the user may open the housing assembly 72 by unlocking the locking mechanism 86 and opening the two cylinder halves up so that the tool may be removed from the wire electrodes. It should be appreciated that means for automatically rotating or turning the tool may be used instead of the manual means described above, and that the tool and/or the automatic rotating means may be mounted in some type of fixture.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, it is not necessary that the tool described above be specifically used with wire electrodes intended for GMAW systems. The tool may be used to finish any joint or junction between two or more wires or other consumable electrodes. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A tool for finishing a weld joint, comprising:
a housing assembly having a first housing member, a second housing member and an internal bore, wherein the internal bore is located between the first and second housing members; and
a cutting device being mounted in the housing assembly and having a cutting surface extending into the internal bore;
wherein in an open position the first and second housing members are separated from each other so that the internal bore can receive the weld joint, and in a closed position the first and second housing members are brought together so that the cutting surface can finish the weld joint.

2. The tool of claim 1, wherein the housing assembly is generally cylindrical and the first and second housing members are cylindrical halves split along an axial direction of the housing assembly.

3. The tool of claim 2, wherein each of the first and second housing members includes an interior surface with a groove, and when the tool is in the closed position the grooves in the first and second housing members define the internal bore.

4. The tool of claim 3, wherein at least one of the grooves in the first and second housing members includes a first groove segment, a second groove segment and a third groove segment, and when the tool is in the closed position the first groove segment is located on a first side of the weld joint and opposes a first wire electrode, the second groove segment is located on a second side of the weld joint and opposes a second wire electrode, and the third groove segment is located between the first and second groove segments and encompasses the weld joint of the first and second wire electrodes and accommodates the cutting device.

5. The tool of claim 1, wherein the housing assembly further includes a hinge that pivotally attaches the first and second housing members together so that they can transition between the open and closed positions.

6. The tool of claim 1, wherein the housing assembly further includes a locking mechanism that attaches the first and second housing members together so that they can lock around the weld joint.

7. The tool of claim 1, wherein the cutting device is mounted in a generally radial direction of the housing assembly so that the cutting surface is at a distal end of the cutting device.

8. The tool of claim 1, wherein the cutting device is mounted in the housing assembly so that it is adjustable and/or replaceable.

9. The tool of claim 1, wherein a separate clamping device maintains two wire electrodes in place while the tool finishes the weld joint.

10. A tool for finishing a weld joint, comprising:
a housing assembly having an internal bore extending the length of the housing assembly; and
a cutting device being mounted in the housing assembly and having a cutting surface extending into the internal bore;
wherein in a closed position the housing assembly surrounds two wire electrodes that are connected together by the weld joint so that rotation of the tool around the two electrodes causes the cutting surface to finish the weld joint.

11. The tool of claim 10, wherein the housing assembly further includes a first housing member and a second housing member, and the internal bore is located between the first and second housing members.

12. The tool of claim 11, wherein the housing assembly is generally cylindrical and the first and second housing members are cylindrical halves split along an axial direction of the housing assembly.

13. The tool of claim 12, wherein each of the first and second housing members includes an interior surface with a groove, and when the tool is in the closed position the grooves in the first and second housing members define the internal bore.

14. The tool of claim 13, wherein at least one of the grooves in the first and second housing members includes a first groove segment, a second groove segment and a third groove segment, and when the tool is in the closed position the first groove segment is located on a first side of the weld joint and opposes a first wire electrode, the second groove segment is located on a second side of the weld joint and opposes a second wire electrode, and the third groove segment is located between the first and second groove segments and encapsulates the weld joint and accommodates the cutting device.

15. The tool of claim 10, wherein the housing assembly further includes a hinge that pivotally attaches the first and second housing members together so that they can transition between the open and closed positions.

16. The tool of claim 10, wherein the housing assembly further includes a locking mechanism that attaches the first and second housing members together so that they can lock around the weld joint.

17. The tool of claim 10, wherein the cutting device is mounted in a generally radial direction of the housing assembly so that the cutting surface is at a distal end of the cutting device.

18. The tool of claim 10, wherein the cutting device is mounted in the housing assembly so that it is adjustable and/or replaceable.

19. The tool of claim 10, wherein a separate clamping device maintains the two wire electrodes in place while the tool finishes the weld joint.
